(19) United States
(12) Patent Application Publication
(10) Pub. No.: US 2018/0305028 A1
(43) Pub. Date: Oct. 25, 2018

(54) MULTIPOSITION AIR INTAKE SYSTEM FOR AN AIRCRAFT

(71) Applicant: Airbus Operations SAS, Toulouse (FR)

(72) Inventors: Bernard Guering, Montrabe (FR); Laurent SAINT-MARC, MONTAIGUT SUR SAVE (FR)

(21) Appl. No.: 15/959,899

(22) Filed: Apr. 23, 2018

(30) Foreign Application Priority Data
Apr. 25, 2017 (FR) 1753563

(51) Int. Cl. B64D 13/06

(52) U.S. Cl. CPC B64D 13/06; B64D 2013/0618

(57) ABSTRACT

An air intake system for an aircraft having a ventral fairing and comprising a scoop having a ventral wall with a first coupling and an opening. The scoop is movable between a flush position in which the ventral wall is flush with the ventral fairing and a catchment position in which the opening is beneath the ventral fairing, and the ventral wall is pierced by a through hole designed to be connected to a flexible pipe of an air conditioning unit. A hatch is movably mounted on the scoop between an open position not blocking the opening and a closed position blocking the opening, the open position can be attained only when the scoop is in the catchment position. A return element forces the hatch into the closed position, and a plug has a second coupling which cooperates with the first coupling to removably secure the plug.

### CROSS-REFERENCES TO RELATED APPLICATIONS

This application claims the benefit of the French patent application No. 1753563 filed on Apr. 25, 2017, the entire disclosures of which are incorporated herein by way of reference.

### TECHNICAL FIELD

The present invention relates to an air intake system for an aircraft which is able to perform various functions according to its position, as well as an aircraft having such an air intake system.

### BACKGROUND OF THE INVENTION

An aircraft typically has an air conditioning system which supplies conditioned air to the cabin of the aircraft.

When an aircraft is on the ground and unable to generate its conditioned air itself, it is arranged to supply this aircraft with conditioned air by means of an air conditioning unit which comprises a generator assembly for conditioned air and a flexible pipe connected to a conditioned air outlet of the conditioned air generator assembly.

In order to connect the flexible pipe to the conditioned air system of the aircraft, the latter has an air conditioning unit intake also known as the LPGC or Low Pressure Ground Connector.

When an incident occurs in the air, it is arranged to supply the air conditioning system with outside air which is taken in through a dynamic emergency air intake also known as the ERAI or Emergency Ram Air Intake.

FIG. 6 is a perspective view of an air intake system 500 of the prior art which is installed on the inside of an aircraft represented here by its ventral fairing 502.

The air intake system 500 comprises an air conditioning unit intake 504 and a scoop 506 which are both installed on the outside of a sheath 508 by means of a Y-branch. The sheath 508 is connected furthermore to a distribution center which redirects the air to the appropriate installations of the aircraft.

The air conditioning unit intake 504 is secured here to a plate 510 which is itself suspended by four connecting rods 512, each of them being secured to the structure of the aircraft by a fixture.

In order to access the air conditioning unit intake 504 from the outside of the aircraft, the ventral fairing 502 is provided with a hatch 514 behind which the air conditioning unit intake 504 is installed. After opening the hatch 514, the flexible pipe of the air conditioning unit is secured to the air conditioning unit intake 504 via a suitable type of connection, in particular a bayonet type attachment.

The scoop 506 is mounted movably in rotation between a flush position (represented in FIG. 6) and a catchment position. In the flush position, the lower wall of the scoop 506 is flush with the ventral fairing 502 and no air can be taken in. In the catchment position, the scoop 506 is tilted downward so as to present its opening 516 beneath the ventral fairing 502 and in the outer air flow, in order to take in air.

The displacement of the scoop 506 is accomplished by means of mechanical actuation, for example such as jacks controlled by a control unit of the aircraft.

In order to manage the movement of the air, the air intake system 500 likewise comprises three valves 518a-c which are opened or closed according to the need of the aircraft for air.

Although such an intake system 500 is entirely satisfactory at present, it uses many elements.

### SUMMARY OF THE INVENTION

One purpose of the present invention is to propose an air intake system which is structurally more simple and thus more lightweight.

For this purpose, an air intake system of an aircraft is proposed, having a sheath and a ventral fairing pierced by a window, said air intake system comprising:
a scoop designed to be interfaced with the sheath and having a ventral wall with first coupling means and an opening, said scoop being movable between a flush position in which the ventral wall is intended to be lodged in the window and to be flush with the ventral fairing and in which the opening is intended to be above the ventral fairing, and a catchment position in which the opening is intended to be below the ventral fairing, and the ventral wall being pierced by a through hole designed to be connected to a flexible pipe of an air conditioning unit,
a hatch mounted movably on the scoop between an open position in which the hatch does not block the opening and a closed position in which the hatch blocks the opening, the open position can be take only in the catchment position,
a return element which forces the hatch into the closed position, and
a plug having second coupling means which cooperate with the first coupling means to secure the plug to the ventral wall in order to block the through hole in a removable manner

Such an air intake system is thus structurally simple and more lightweight.

Advantageously, the hatch is mounted movably in rotation on the ventral wall.

Advantageously, an upper wall opposite the ventral wall has an end stop against which the hatch bears in the closed position.

Advantageously, the air intake system is designed to be secured to a flexible pipe of an air conditioning unit, said flexible pipe having coupling means, and the first coupling means are adapted to cooperate with the first coupling means to ensure the removable fixation of the flexible pipe.

Advantageously, the second coupling means are intended to take the same form as the coupling means of the flexible pipe.

Advantageously, the air intake system comprises a flexible connection secured between the plug and the ventral wall.

Advantageously, the plug has means of grasping which are accessible from the outside.

Advantageously, the means of grasping take the form of at least one cap fitted into an opening of the plug, and hinged to retract inside the hole and free up the opening.

The invention likewise proposes an aircraft comprising a sheath, a ventral fairing pierced by a window, an air intake system according to the preceding variant, and means of mechanical actuation provided to move the scoop from the flush position to the catchment position and vice versa.

Advantageously, the ventral fairing has, on the side oriented toward the outside, a housing designed to accommodate the plug.

Advantageously, the scoop is positioned with its opening oriented toward the front of the aircraft.

The invention likewise proposes an assembly comprising an aircraft according to the preceding variant, and an air conditioning unit comprising a flexible pipe with coupling means which cooperate with the first coupling means when the plug is removed.

### BRIEF DESCRIPTION OF THE DRAWINGS

The characteristics of the invention mentioned above, as well as others, will appear more clearly upon reading the following description of an exemplary embodiment, said description being given in relation to the enclosed drawings, among which:

FIG. 1 is a side view of an aircraft according to the invention,

FIG. 2 is a perspective view of an air intake system according to the invention,

FIG. 3 is a cross section by the vertical plane III of FIG. 2 through a portion of the air intake system in a first position of use,

FIG. 4 is a view similar to that of FIG. 3 in a second position of use,

FIG. 5 is a view similar to that of FIG. 3 in a third second position of use, and

FIG. 6 is a perspective view of an air intake system of the prior art.

### DETAILED DESCRIPTION OF THE PREFERRED EMBODIMENTS

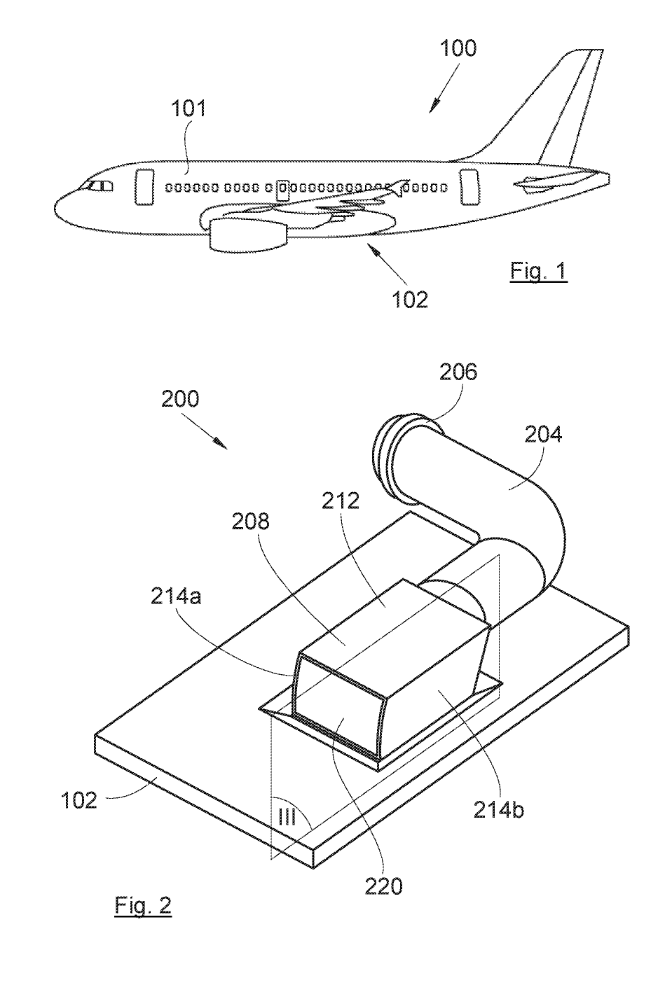

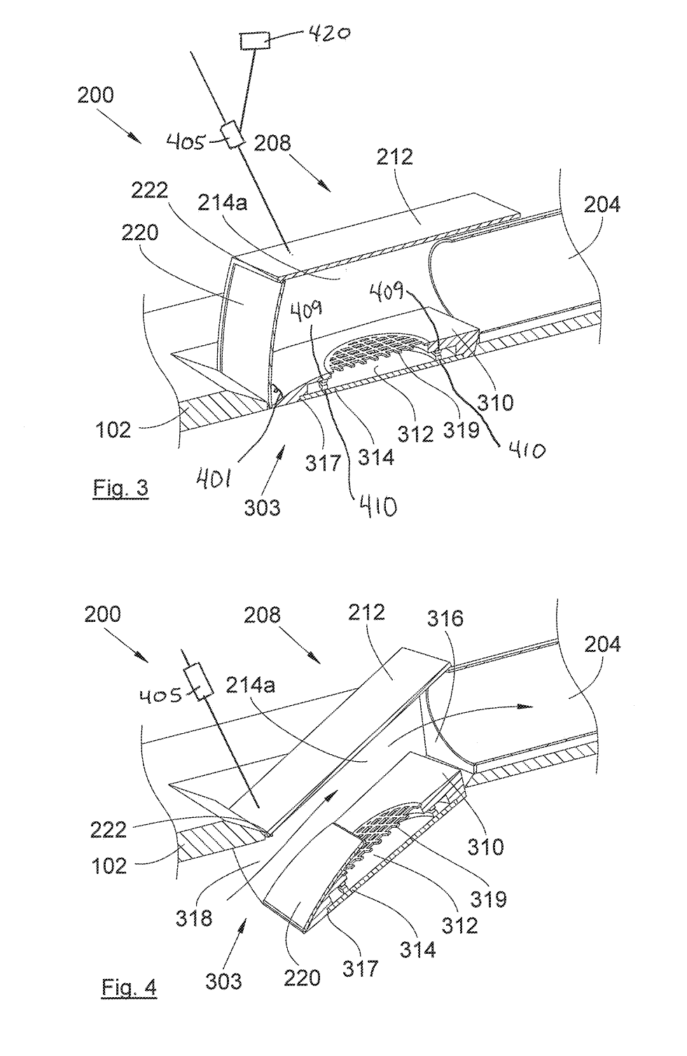

FIG. 1 shows an aircraft 100 comprising a fuselage 101 which has a ventral fairing 102 in its lower portion. The ventral fairing 102 is pierced by a window (303 FIG. 3 to 5) through which an air intake system according to the invention is arranged.

FIGS. 2 to 5 show the air intake system 200 mounted on the ventral fairing 102 and secured to one end of a sheath 204 which is also connected to a distribution center which redirects the air to the appropriate installations of the aircraft 100.

In the embodiment of the invention shown here, a check valve 206 is disposed between the air intake system 200 and the sheath 204. The check valve 206 allows the circulation of air coming from the air intake system 200 through the sheath 204 and up to the distribution center, and the check valve 206 prevents the circulation of air coming from the distribution center and going to the sheath 204 and the air intake system 200 and thus to the outside. Thus, in this embodiment, there is a single valve 206 instead of three as in the prior art.

The air intake system 200 comprises a scoop 208 which has here the overall form of a parallelepiped comprising a ventral wall 310, an upper wall 212 opposite to and parallel with the ventral wall 310, two parallel lateral walls 214a-b and a rear wall 316 (which can be seen in FIG. 4) ensuring the interface and the seal with the sheath 204. On the opposite side from the rear wall 316, the scoop 208 has an opening 318.

As with the air intake system of the prior art, the scoop 208 of the air intake system 200 according to the invention is mounted movably in rotation between a flush position (FIGS. 2, 3 and 5) and a catchment position (FIG. 4).

In the flush position, the ventral wall 310 constituting the underside of the scoop 208 is flush with the ventral fairing 102 and the opening 318 is above the ventral fairing 102, that is, inside the aircraft 100. In the flush position, the ventral wall 310 is lodged in the window 303 and blocks it.

In the catchment position, the scoop 208 is tilted downward so as to present its opening 318 beneath the ventral fairing 102 and in the flow of outside air, in order to take in air. In the catchment position, the ventral wall 310 is no longer continuous with the ventral fairing 102 but rather protrudes in relation to it.

The scoop 208 is positioned with its opening 318 oriented toward the front of the aircraft 100, and the scoop 208 is mounted movably in rotation about an axis of rotation which is horizontal and perpendicular to the direction of progression of the aircraft 100. The axis of rotation is located here behind the scoop 208.

The displacement of the scoop 208 from the flush position to the catchment position and vice versa is accomplished by means of mechanical actuation 405, such as jacks, or a motor, etc., controlled by a control unit 420 of the aircraft 100 (FIG. 3).

The air intake system 200 likewise comprises a hatch 220 which is mounted movably on the scoop 208 between an open position (FIG. 4) and a closed position (FIGS. 2, 3 and 5). In the open position, the hatch 220 does not block the opening 318 and it allows the entry of air into the scoop 208. In the closed position, the hatch 220 blocks the opening 318 and prevents the entry of air into the scoop 208 through the opening 318 and the exiting of air from the scoop 208 through the opening 318.

In order to force the hatch 220 into the closed position, the air intake system 200 comprises a return element 401, such as a spring, which forces the hatch 220 into the closed position.

In the embodiment of the invention presented in FIGS. 2 to 5, the hatch 220 is mounted movably in rotation on the ventral wall 310, but it is possible to arrange for it to be mounted movably in rotation on another wall of the scoop 208, in particular on the upper wall 212.

In the embodiment of the invention presented here, the upper wall 212 has an end stop 222 which limits the displacement of the hatch 220 and locks it in the closed position. The hatch 220 thus comes to bear against the end stop 222 in the closed position and prevents the hatch 220 from moving beyond the closed position.

In the event that the hatch 220 is mounted movably in rotation on the upper wall 212, the end stop 222 is placed on the ventral wall 310.

The ventral wall 310 has a through hole 312 designed to be connected to a flexible pipe 407 of an air conditioning unit 406. The through hole 312 connects the outside of the aircraft 100 and the inside of the scoop 208, and the air intake system 200 comprises a plug 314 which is attached in removable manner to the lower face of the ventral wall 310, that is, the face oriented toward the outside. Thus, the plug 314 may be attached to the ventral wall 310 in order to block the through hole 312, or it may be removed to unblock the through hole 312.

The ventral wall 310 has first coupling means 409.

In order to ensure the removable attachment of the plug 314 to the ventral wall 310, the plug 314 has second coupling means 410 which cooperate with the first coupling means.

Preferably, the first coupling means 409 are adapted to an attachment of the flexible pipe 407 of the air-conditioning unit 406, having for this purpose coupling means 408 which cooperate with the first coupling means to ensure the removable attachment of the flexible pipe to the ventral wall 310. The first coupling means 409 and the coupling means for example take the form of a bayonet attachment and the attachment then occurs by rotation of the flexible pipe about its axis.

Preferably, the second coupling means 410 take the same form as the coupling means 408 of the flexible pipe, for example, a bayonet attachment.

In order to ensure aerodynamical continuity between the outer surface of the ventral fairing 102 and the plug 314, the ventral fairing 102 has, on the side oriented toward the outside, a housing 317 designed to accommodate the plug 314. The depth of the housing 317 is equal to the height of the plug 314.

Such an air intake system 200 is thus able to perform the functions of two distinct assemblies of the prior art, thus providing a saving in space and weight.

The operation of the air intake system 200 is thus as follows.

In flight (FIG. 3), the plug 314 is in place and blocks the through hole 312, and the scoop 208 is placed in the flush position. The outside air is not captured by the scoop 208 and the plug 314 and the ventral wall 310 ensure the aerodynamical continuity of the ventral fairing 102.

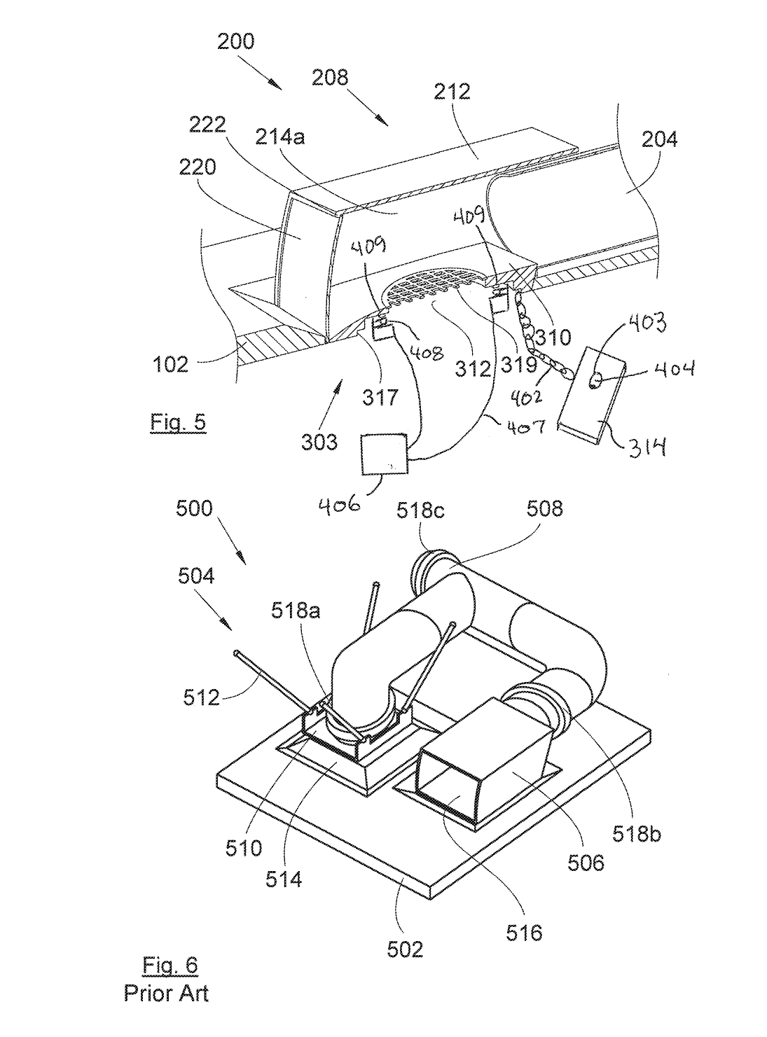

On the ground (FIG. 5), when the aircraft 100 is supplied by an air conditioning unit, the scoop 208 is placed in the flush position and the plug 314 is removed in order to attach the flexible pipe. The air is then routed through the through hole 312, the scoop 208 and the sheath 204. The pressure inside the scoop 208 pushes against the hatch 220, which remains in the closed position.

In event of an incident in flight (FIG. 4), the scoop 208 is placed in the catchment position and the plug 314 is in place and blocks the through hole 312. The force of the return element is enough to maintain the hatch 220 in the closed position, but not enough to compensate for the pressure exerted by the outside air on the hatch 220 in flight. The air is then routed through the opening 318, the scoop 208 and the sheath 204.

The check valve 206 makes it possible to allow or prevent the routing of air from the air intake system 200 to the distribution center.

In order to prevent the falling of the plug 314 when it is detached from the ventral wall 310, the air intake system 200 has a flexible connection 402, such as the chain type, secured between the plug 314 and the ventral wall 310.

In order to prevent objects from getting inside the sheath 204, the air intake system 200 has a grill 319 secured to the ventral wall 310 across the through hole 312.

In order to be handled, the plug 314 has grasping means 403 which are accessible from the outside of the ventral fairing 102. This might be, for example, at least one cap 404 which is fitted inside an opening 403 of the plug 314. Each cap 404 is hinged for example about a hinge in order to be retracted inside the hole 312 and to free up the opening 403.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An air intake system of an aircraft having a sheath and a ventral fairing pierced by a window, said air intake system comprising:
a scoop configured to interface with the sheath and having a ventral wall with a first coupling, and an opening,
said scoop being movable between a flush position in which the ventral wall is lodged in the window and flush with the ventral fairing and in which the opening is above the ventral fairing, and a catchment position in which the opening is below the ventral fairing, and
the ventral wall being pierced by a through hole configured to connect with a flexible pipe of an air conditioning unit,
a hatch mounted movably on the scoop between an open position in which the hatch does not block the opening and a closed position in which the hatch blocks the opening, the open position being possible only when the scoop is in the catchment position,
a return element which forces the hatch into the closed position, and
a plug having second coupling means which cooperate with the first coupling means to secure the plug to the ventral wall to block the through hole in a removable manner

2. The air intake system according to claim 1, wherein the hatch is mounted movably in rotation on the ventral wall.

3. The air intake system according to claim 2, wherein an upper wall opposite the ventral wall has an end stop against which the hatch bears in the closed position.

4. The air intake system according to claim 1, wherein the air intake system is configured to be secured to a flexible pipe of an air conditioning unit, said flexible pipe having coupling means, and wherein the flexible pipe coupling means are configured to cooperate with the first coupling means to ensure the removable fixation of the flexible pipe.

5. The air intake system according to claim 4, wherein the second coupling means take the same form as the coupling means of the flexible pipe.

6. The air intake system according to claim 1, further comprising a flexible connection secured between the plug and the ventral wall.

7. The air intake system according to claim 1, wherein the plug has means of grasping which are accessible from the outside.

8. The air intake system according to claim 7, wherein the means of grasping take the form of at least one cap fitted into an opening of the plug, and hinged to retract inside the hole and free up the opening.

9. An aircraft comprising a sheath, a ventral fairing pierced by a window, an air intake system according to claim 1, and means of mechanical actuation provided to move the scoop from the flush position to the catchment position and vice versa.

10. The aircraft according to claim 9, wherein the ventral fairing has, on the side oriented toward the outside, a housing configured to accommodate the plug.

11. The aircraft according to claim 9, wherein the scoop is positioned with the opening oriented toward a front of the aircraft.

12. An assembly comprising an aircraft according to claim 9, and an air conditioning unit comprising a flexible pipe with coupling means which cooperate with the first coupling means when the plug is removed from the ventral wall.
